(19) United States
(12) Patent Application Publication
(10) Pub. No.: US 2026/0010966 A1
(43) Pub. Date: Jan. 8, 2026

(54) SYSTEMS AND METHODS FOR CUSTOMIZED WEATHER ALERTING

(71) Applicant: State Farm Mutual Automobile Insurance Company, Bloomington, IL (US)

(72) Inventor: Elizabeth Schell, Alpharetta, GA (US)

(73) Assignee: State Farm Mutual Automobile Insurance Company, Bloomington, IL (US)

(21) Appl. No.: 19/257,257

(22) Filed: Jul. 1, 2025

Related U.S. Application Data
(60) Provisional application No. 63/667,309, filed on Jul. 3, 2024.
(60) Provisional application No. 63/767,924, filed on Mar. 6, 2025.

(51) Int. Cl. G06Q 50/26; G06F 16/9537

(52) U.S. Cl. CPC G06Q 50/265; G06F 16/9537

(57) ABSTRACT

A system for generating customized alerts for a user may (1) receive weather data from a database; (2) determine, from the weather data, weather conditions indicative of a predicted weather event beginning within a predefined time period; (3) receive a location of the user; (4) receive information relating to one or more protection policies of the user; (5) determine that the predicted weather event is relevant to the user based upon the location of the user and the information relating to the one or more protection policies of the user for protecting at least one of the user or property of the user; and (6) automatically initiate an action to mitigate a potential impact of the predicted weather event on the user responsive to the determination that the predicted weather event is relevant to the user.

### CROSS-REFERENCE TO RELATED PATENT APPLICATIONS

This application claims the benefit of and priority to U.S. Provisional Patent Application No. 63/667,309, filed on Jul. 3, 2024, and U.S. Provisional Patent Application No. 63/767,924, filed on Mar. 6, 2025, the entire disclosures of which are hereby incorporated by reference herein.

### FIELD OF THE INVENTION

The present disclosure generally relates to notification systems. More particularly, the present systems and methods relate to using a utilizing weather data and policy information of a user to automatically initiate actions to mitigate an impact of the weather data on the user.

### BACKGROUND

Individuals may receive notifications alerting them of impending weather events. For example, an individual receives a notification that a thunderstorm will occur in the individual's area in a predetermined period of time. However, these conventional notifications may not be useful to the individual or may contain unhelpful information relevant to the individual. It may be beneficial to provide individuals with notifications indicative of a weather event with enough notice that the user can take action to prepare for the weather event. Conventional techniques may include additional ineffectiveness, encumbrances, inefficiencies, and other drawbacks as well.

### BRIEF SUMMARY

A weather alert computer system may be provided that, inter alia, generates customized weather alert notifications for a user, such as to facilitate providing relevant information to users. For instance, weather conditions for various locations may be analyzed along with information relating to users and/or policies to determine weather events that may impact the user. A user interface may be presented to a user, such as on a mobile device or other computing device, displaying a notification including a type of weather event predicted to occur.

In one aspect, a system for generating customized weather alerts for a user and/or mitigating the impact of weather events may be provided. The computer system may include one or more local or remote processors, servers, transceivers, sensors, memory units, mobile devices, wearables, smart watches, smart rings, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another. For example, in one instance, the computer system may include one or more processors and one or more non-transitory memories storing processor-executable instructions that, when executed by the one or more processors, cause the system to perform several operations, including (1) receiving weather data from a database; (2) determining, from the weather data, weather conditions indicative of a predicted weather event beginning within a predefined time period; (3) receiving a location of the user; (4) receiving information relating to one or more protection policies of the user; (5) determining that the predicted weather event is relevant to the user based upon the location of the user and the information relating to the one or more protection policies of the user for protecting at least one of the user or property of the user; and/or (6) automatically initiating an action to mitigate a potential impact of the predicted weather event on the user responsive to the determination that the predicted weather event is relevant to the user. The computer system may include additional, less, or alternate functionality and/or operations, including that discussed elsewhere herein.

For instance, in certain embodiments, automatically initiating the action may include (i) generating a notification for the user based upon the determination that the predicted weather event is relevant to the user based upon, at least one of the weather conditions, the location of the user, and the information relating to the one or more protection policies of the user, the notification comprising information related to the predicted weather event, and/or (ii) displaying the notification to the user a length of time before the beginning of the predicted weather event. The notification may include information relevant to the predicted weather event.

In various implementations, the functionality and/or operations may include determining the weather conditions at a current location of the user by extracting weather data from the database for a geographical area within a predefined distance from the current location of the user.

In some implementations, the information relating to the one or more policies may include at least one of: (i) an address of a building.

In some implementations, the functionality and/or operations may include (i) receiving, from the database, a plurality of predetermined notifications relating to the weather data, (ii) selecting at least one of the plurality of predetermined notifications relating to the weather data, and/or (iii) displaying the at least one of the plurality of predetermined notifications to the user or otherwise providing, presenting, or outputting the notification to a user, such as audibly via a voice bot or chatbot, or visually or graphically via a computing device display, such as a mobile device, VR headset, AR glasses, a smart vehicle control console or display, or other computing devices, including those mentioned elsewhere herein.

In certain embodiments, functionality and/or operations may include (i) determining that the predicted weather event is occurring or predicted to occur at or near a location of an asset of the user, and/or (ii) displaying at least one of the plurality of predetermined notifications to the user based on the determination that the predicted weather event is occurring or predicted to occur at or near the location of the asset of the user or otherwise providing, presenting, or outputting the notification to a user, such as audibly via a voice bot or chatbot, or visually or graphically via a computing device display, such as a mobile device, VR headset, AR glasses, a smart vehicle control console or display, or other computing devices, including those mentioned elsewhere herein.

In another aspect, a computer-implemented method for generating customized weather alerts for a user and/or mitigating the impact of weather events may be provided. The computer-implemented method may be implemented via one or more local or remote processors, servers, transceivers, sensors, memory units, mobile devices, wearables, smart watches, smart rings smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another. In one instance, the computer-implemented method may include, such as via one or more local or remote processors, transceivers, sensors, other electronic components, including those discussed elsewhere herein, and/or computer-readable storage media having instructions stored thereon executable by the processors, transceivers, sensors, and/or other electronic components, (1) receiving, by one or more processors, weather data from a database; (2) determining, by the one or more processors, from the weather data, weather conditions indicative of a predicted weather event beginning within a predefined time period; (3) receiving, by the one or more processors, a location of a user; (4) receiving, by the one or more processors, information relating to one or more policies of the user; (5) determining that the predicted weather event is relevant to the user based upon the location of the user and the information relating to the one or more policies of the user for protecting at least one of the user or property of the user; and/or (6) automatically initiating an action to mitigate a potential impact of the predicted weather event on the user responsive to the determination that the predicted weather event is relevant to the user. The method may include additional, less, or alternate functionality, including that discussed elsewhere herein.

For instance, automatically initiating the action may include (i) generating a notification for the user based upon the determination that the predicted weather event is relevant to the user based upon, at least in part, at least one of: the weather conditions, the location of the user, and the information relating to the one or more policies of the user and/or other data types, including those mentioned elsewhere herein. In some implementations, the notification may include information relevant to the predicted weather event. In certain implementations, automatically initiating the action may include (ii) displaying the notification to the user a predetermined length of time before the beginning of the predicted weather event.

In various implementations, the computer-implemented method may include determining the weather conditions at a current location of the user by extracting weather data from the database for a geographical area within a predefined distance from the current location of the user.

In some implementations, the information relating to the one or more policies may include at least one of: (i) an address of a building.

In some implementations, the computer-implemented method may include (i) receiving, from the database, a plurality of predetermined notifications relating to the weather data, (ii) selecting at least one of the plurality of predetermined notifications relating to the weather data, and/or (iii) displaying the at least one of the plurality of predetermined notifications to the user or otherwise providing, presenting, or outputting the notification to a user, such as audibly via a voice bot or chatbot, or visually or graphically via a computing device display, such as a mobile device, VR headset, AR glasses, a smart vehicle control console or display, or other computing devices, including those mentioned elsewhere herein.

In certain embodiments, computer-implemented method may include (i) determining that the predicted weather event is occurring or predicted to occur at or near a location of an asset of the user, and/or (ii) displaying at least one of the plurality of predetermined notifications to the user based on the determination that the predicted weather event is occurring or predicted to occur at or near the location of the asset of the user or otherwise providing, presenting, or outputting the notification to a user, such as audibly via a voice bot or chatbot, or visually or graphically via a computing device display, such as a mobile device, VR headset, AR glasses, a smart vehicle control console or display, or other computing devices, including those mentioned elsewhere herein.

In another aspect, a non-transitory computer readable medium having instructions stored thereon that, when executed by one or more processors, cause the one or more processors to perform various functionality and operations. For instance, the functionality and operations may include or direct (1) receiving weather data from a database; (2) determining, from the weather data, weather conditions indicative of a predicted weather event beginning within a predefined time period; (3) receiving, a location of a user; (4) receiving information relating to one or more policies of the user; (5) determining that the predicted weather event is relevant to the user based upon the location of the user and the information relating to the one or more protection policies of the user for protecting at least one of the user or property of the user; and/or (6) automatically initiating an action to mitigate a potential impact of the predicted weather event on the user responsive to the determination that the predicted weather event is relevant to the user. The instructions may direct additional, less, or alternate functionality and/or operations, including that discussed elsewhere herein.

For instance, in some implementations, the functionality and operations may include (i) generating a notification for the user based upon the determination that the predicted weather event is relevant to the user based upon, at least one of: the weather conditions, the location of the user, and the information relating to the one or more policies of the user. In certain embodiments, the notification may include information relevant to the predicted weather event.

In various implementations, the functionality and/or operations may include determining the weather conditions at a current location of the user by extracting weather data from the database for a geographical area within a predefined distance from the current location of the user.

In some implementations, the information relating to the one or more policies may include at least one of: (i) an address of a building.

In some implementations, the functionality and/or operations may include (i) receiving, from the database, a plurality of predetermined notifications relating to the weather data, (ii) selecting at least one of the plurality of predetermined notifications relating to the weather data, and/or (iii) displaying the at least one of the plurality of predetermined notifications to the user or otherwise providing, presenting, or outputting the notification to a user, such as audibly via a voice bot or chatbot, or visually or graphically via a computing device display, such as a mobile device, VR headset, AR glasses, a smart vehicle control console or display, or other computing devices, including those mentioned elsewhere herein.

In certain embodiments, functionality and/or operations may include (i) determining that the predicted weather event is occurring or predicted to occur at or near a location of an asset of the user, and/or (ii) displaying at least one of the plurality of predetermined notifications to the user based on the determination that the predicted weather event is occurring or predicted to occur at or near the location of the asset of the user or otherwise providing, presenting, or outputting the notification to a user, such as audibly via a voice bot or chatbot, or visually or graphically via a computing device display, such as a mobile device, VR headset, AR glasses, a smart vehicle control console or display, or other computing devices, including those mentioned elsewhere herein.

Advantages will become more apparent to those skilled in the art from the following description of embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

There are shown in the drawings arrangements which are presently discussed, it being understood, however, that the present embodiments are not limited to the precise arrangements and are instrumentalities shown, wherein:

FIG. 1 is a block diagram of an exemplary weather alert computer system, according to some embodiments.

FIG. 2 is a block diagram of an exemplary notification generation system, according to some embodiments.

FIG. 3 is a flow diagram of an exemplary computer-implemented or computer-based process of generating a customized notification relating to a predicted weather event, according to some embodiments.

FIG. 4 is a diagram of an exemplary user interface displaying customized notifications, according to some embodiments.

FIG. 5 is diagram of exemplary weather alerts to be customized based upon an protection policy of a user, according to some embodiments.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments relate to, inter alia, a weather alert computer system that generates customized notifications responsive to predicted weather events. For instance, the system may receive weather information and information relating to a user (e.g., a policyholder) having a protection policy associated with a provider (e.g., an insurance provider) for protecting the user and/or property of the user. The system may also receive details about the protection policy and/or assets covered by the policy. The system may determine that a weather event is predicted to occur in a location of the user and/or a location of an asset. Responsive to this determination, the system may automatically initiate an action to mitigate a potential impact of the weather event on the user and/or the asset. The automatically initiated action may include generating a notification to display to the user.

### Overview

Referring to the Figures, computer systems and computer-implemented methods for generating a notification indicating an upcoming or predicted weather event. The notification may be provided in advance such that the user is able to take action to minimize a potential impact of a weather event on a person (e.g., the user) or asset. For example, the computer system may be configured to receive weather data and determine weather conditions indicative of a predicted weather event beginning within a predefined time period. The system may also receive a location of a user and information relating to one or more policies of the user.

Using the weather data, the location of the user, and the information relating to the one or more policies, the system may determine that the predicted weather event is relevant to the user. Responsive to the determination, the system may automatically initiate an action to mitigate a potential impact of the predicted weather event on the user.

Various weather events and phenomena may be occurring with greater intensity, frequency, etc. For example, climate change and severe weather may be impacting both customers and providers in a variety of ways. Customers or individuals may face damage or other impacts to themselves and/or their assets or belongings due to weather events. For instance, hailstorms and windstorms may damage vehicle or homes, and flash floods may cause dangerous or difficult driving conditions for drivers. Advantageously, the systems and methods described herein may allow a customer of a provider institution (e.g., a user of an insurance provider) to receive a notification indicating a weather event in a geographic area of the user. The notification may include information relevant to the user.

Receiving a customized notification may be beneficial to a user to protect themselves and their assets from damage and potential costs associated with repairing any damage. For example, a user may receive information about a weather event and/or information about assets of the user. In some implementations, the information may be received with enough time prior to the weather event occurring that the user can take action to protect themselves and/or their assets. Thus, a user may be protected and their assets may be protected from potentially harmful situations.

Additionally, the systems and methods described herein may be advantageous to a provider system (e.g., an insurance provider). By providing a notification to a customer early enough before a weather event that the user can take proactive actions, users of the provider may file fewer claims relating to accidents, injuries, damages, etc. resulting from inclement weather events. This may be beneficial to the provider and/or other entities contracted by the user or the provider in a variety of ways, such as reduced financial impact, reducing human and other resources needed to fix weather-related issues after a weather event, etc.

Advantageously, generating custom notifications to users may offer a reduction in computing resources or power for the provider. Because notification may only be generated when a weather event is determined to be relevant to a user, not every user associated with the provider may receive a notification every time a weather event occurs. Thus, the system may reduce a number of actions performed compared to delivering non-customized notifications to every associated user. This may also result in a greater degree of action and/or attention by the user based upon the generated notifications being more likely to be relevant to the user.

Further, the use of various weather databases by the provider may reduce computing resources. For example, in various embodiments, the provider may customize predetermined weather notifications to include information specific to users. This may reduce computing resourced because the computing system would not spend processing time and power to generate an entire notification and instead may provide enhancements to an already-generated notification. Thus, the provider may spend fewer resources curating complex data and may instead spend resources utilizing data, analyzing data, and generating notifications to improve the provider and the users.

Exemplary Weather Alert System with Custom Notifications

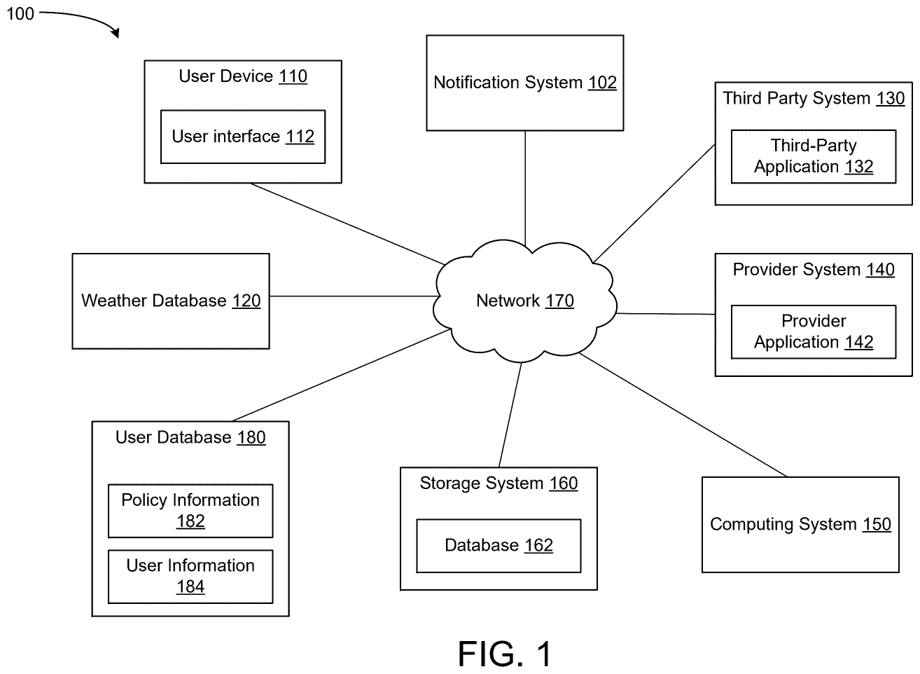

Referring to FIG. 1, a block diagram of an exemplary weather alert computer system, shown as weather alert system 100, is shown, according to some embodiments. The weather alert system 100 and/or one or more components of the weather alert system may be associated with an insurance provider. The weather alert system 100 may include a notification generation system, shown as notification system 102, a user device 110 having a user interface 112, and a weather database, shown as weather database 120. The weather alert system 100 may also include a third-party system 130 having a third-party application 132, a provider system 140 having a provider application 142, and a computing system 150.

The weather alert system 100 may also include a storage system 160 having a database 162 and a user database 180 storing policy information 182 and user information 184. The components of the weather alert system 100 may be connected, or in wired or wireless communication, via a network 170. It should be noted that the number and type of components shown is merely illustrative and, in some embodiments, implementations of the weather alert system 100 may have additional, fewer, and/or different components than those illustrated in FIG. 1, including those mentioned elsewhere herein.

As will be discussed in greater detail below, the notification system 102 may be configured to generate and/or provide (such as visually or audibly via one or more computing devices) one or more notifications. For example, the notification system 102 may be configured to receive weather data from the weather database 120. The notification system 102 may also receive information from the user database 180 relating to a user and one or more protection policies of the user (e.g., a type of insurance policy, covered assets, a location of the assets, a location of the user, etc.). The weather data received by the notification system 102 may include a plurality of upcoming or predicted weather events to occur within a predefined time period. The notification system 102 may determine, from the weather data, predicted weather events in a location proximate a location of the user and/or a location of one or more assets of the user (e.g., assets covered by a policy of the user).

The notification system 102 may generate a notification to be transmitted to the user that includes information indicative of a weather event occurring at a location of the user and/or a location of one or more assets of the user. For example, the notification system 102 may determine that a hailstorm is predicted to occur in an area in which a vehicle covered by an auto insurance policy of the user is located. The notification system 102 may then generate a notification including an indication that a hailstorm is occurring in a location of the user and/or a location of the vehicle.

In some implementations, the notification system 102 may receive weather data from a database. For example, the notification system 102 may receive weather data from the weather database 120. The weather data stored in the weather database may include weather conditions and predicted weather events for various locations.

The notification system 102 may selectively retrieve weather information for specific locations of interest. For instance, the notification system 102 may generate notifications for a specific zip code. The notification system 102 may selectively retrieve weather conditions for the specific zip code. This may reduce processing times for data retrieval and increase storage space on, for example, a memory device.

The notification system 102 may determine, using the weather data, weather conditions indicative of a predicted weather event. Weather conditions may include, for example, extreme high or low temperatures, precipitation, high or low pressure systems, etc. The weather conditions may indicate a predicted weather event. For example, the predicted weather event may include a heat wave, a snowstorm, a tornado, a thunderstorm, etc. The notification system 102 may determine that the predicted weather event begins within a predefined time period (e.g., thirty minutes, two hours, three days, etc.).

In various embodiments, the notification system 102 may receive a location of a user. The user may be a customer of an insurance provider having one or more policies through the insurance provider (i.e., the user is a policyholder of the insurance provider). The location of the user may be a current location, a live or real-time location, etc. The notification system 102 may also receive information relating to the user. The information relating to the user may include, for example, an age of the user, a number of dependents of the user, driving habits of the user and/or dependents, historical location data, etc. The notification system 102 may receive the information relating to the user from the weather alert system 100 (e.g., from the user database 180) and/or from a third-party provider (e.g., from third-party system 130).

Further, the notification system 102 may receive information relating to one or more policies of the user. The one or more policies may be a homeowner policy, a life policy, a vehicle policy, a health policy, etc. The information relating to the policies may include, for example, an address of a building covered by a policy (e.g., a house covered by a homeowner's policy), etc.

In various embodiments, the notification system 102 may determine weather conditions at a current location of the user. For example, the notification system 102 may extract weather data from the database (e.g., weather database 120) for a geographical area. In various embodiments, the geographical area may or may not be a predefined geographical area. The geographical area may be within a predefined distance from the current location of the user. For example, user may be currently driving on a highway. The notification system 102 may extract weather data for the geographical area within ten miles of the user's current location on the highway.

In various embodiments, the notification system 102 may determine weather conditions at a location of at least one asset covered by at least one of the policies of the user. For example, the notification system 102 may extract weather data from the database (e.g., weather database 120) for a geographical area. Additionally, the geographical area may be within a predefined distance from the at least one asset. For instance, the notification system 102 may extract weather data for a geographical area within ten miles of an address of a building or house of the user covered by a homeowner policy.

The notification system 102 may determine that the predicted weather event is relevant to the user. The notification system 102 may determine the relevance of the predicted weather event based upon the location of the user, and the information relating to the one or more policies. In various embodiments, a predicted weather event relevant to the user may be a predicted weather event in which an asset of the user or the user themself is at risk or being damaged or hurt as a result of the weather event. In certain embodiments, the determination that the predicted weather event is relevant to the user may also be based upon the information relating to the user.

The notification system 102 may also automatically initiate an action to mitigate a potential impact of the predicted weather event on the user and/or an asset of the user. The action may be initiated responsive to the determination that the predicted weather event is relevant to the user.

In various embodiments, the automatically initiated action may include generating a notification for the user. The notification may be based upon the determination that the predicted weather event is relevant to the user based upon the weather conditions, the location of the user, and/or the information relating to the one or more policies of the user. In exemplary implementations, the notification may also be generated based upon the information relating to the user. The notification may include information relevant to the user or at least one policy of the one or more policies.

The notification may be generated responsive to a determination that the predicted weather event impacts the user and/or at least one of the policies. The notification may be displayed to the user a predetermined length of time before the beginning of the predicted weather event. For example, the notification may be displayed to the user thirty minutes before onset of the predicted weather event.

In various embodiments, the predetermined length of time may vary based upon the type of predicted weather event. For instance, if the predicted weather event is a flash flood (e.g., a weather event occurring with little to no prior warning), the predetermined length of time may be shorter than if the predicted weather event is a hurricane (e.g., a weather event occurring with more advanced warning).

The notification system 102 may, alternatively to or in addition to generating the notification, customize a predetermined notification. For example, the notification system 102 may receive, from the weather database (e.g., weather database 120), a plurality of predetermined notifications relating to the weather data. The notification system 102 may customize at least one of the plurality of predetermined notifications. The customizations may be based upon the location of the user, weather data at the location of the user, and/or information relating to the policies of the user. The notification system 102 may display the customized notification to the user.

Referring still to FIG. 1, according to some embodiments, the notification system 102 may be configured to communicate with components of the weather alert system 100. For example, information and/or data associated with the user device 110 and/or the weather database 120 may be communicated to the notification system 102 (e.g., via the network 170). Information and/or data associated with the third-party system 130 and/or the provider system 140 may also be communicated to the notification system 102 (e.g., via the network 170). Information and/or data associated with the computing system 150, the storage system 160, and/or the user database 180 may also be communicated to the notification system 102 (e.g., via the network 170).

In some embodiments, the notification system 102 may be implemented using cloud computing services. The notification system 102 may be implemented using one or more computing devices, for example operating alone and/or in combination. In certain implementations, the notification system 102 may be implemented using computing architectures like multiple distributed servers, and/or similar computing devices and/or systems. In various implementations, the notification system 102 may be another suitable computing system, for example distributed across multiple systems or devices (e.g., which may be located within a single building or facility, or distributed across multiple different buildings or facilities), or within a single computer (e.g., one server, housing, etc.). All such implementations are contemplated herein.

As shown, the notification system 102 may be configured to communicate with the user device 110. The user device 110 may include one or more human-machine interfaces or client interfaces, shown as user interface 112 (e.g., a graphical user interface, a text-based computer interface, a client-facing web service, a web service that provides pages to a web client, etc.), for example for controlling, viewing, and/or otherwise interfacing with the notification system 102. The user device 110 may include a personal mobile computing device (e.g., a smart phone, a tablet, a mobile device, a wearable, smart glasses, a smart watch, etc.). The user device 110 may include a computer workstation, a client terminal, a remote or local interface, and/or any other user interface device. The user device 110 may be a stationary terminal (e.g., a desktop computer, a laptop computer, a tablet, or another suitable non-mobile device).

In some embodiments, information/data associated with the user device 110 may be communicated to the notification system 102. In certain implementations, the user device 110 itself may be configured to communicate information/data to the notification system 102. In various embodiments, a device coupled to the user device 110, a component implemented with the user device 110, an application or program housed and/or executed on the user device 110, and/or another suitable component associated with the user device 110 may be configured to communicate information/data to the notification system 102.

The notification system 102 may transmit a notification to the user device 110 for display (e.g., on the user interface 112). For example, the notification system 102 may generate a customized notification for a user or user of the user device 110. The notification may be displayed on a lock screen of the user device 110. In various embodiments, the notification may be displayed on an application associated with the provider generating the notification. For example, the provider may be an insurance provider and the user device 110 may display the notification on a provider application 142 installed on the user device 110.

The notification system 102 may also be configured to receive information/data associated with the user device 110. For example, the user device 110 may (e.g., automatically, or in response to an input from a user or operator, etc.) communicate geolocation and/or vehicle telematics data (for instance, vehicle telematics data may include acceleration, braking, cornering, location, heading, speed, GPS, and/or other driving data) associated with the user device 110 to the notification system 102.

Moreover, the user device 110 may communicate information associated with a location of the user device 110, a speed and/or direction of movement of the user device 110, a starting/ending location of the user device 110 during a travel event, and/or other similar geolocation and/or telematics data. The user device 110 may communicate real-time and/or historic geolocation and/or telematics data associated with the user device 110 to the notification system 102.

The notification system 102 may utilize the geolocation data and/or vehicle telematics data to determine notifications to display on the user device 110. For example, the notification system 102 may receive telematics data from the user device 110 indicating that the user (e.g., a user or dependent of the user) tends to speed on the highway.

The notification system 102 may use this information to generate a notification indicating that a predicted low visibility weather event is occurring or will occur. For instance, during or prior to a predicted low visibility weather event (e.g., fog, heavy rain, etc.) occurring at or near a current location of the user driving on the highway, the notification system 102 may generate and display a notification indicating that the low visibility weather event will occur.

As shown, information/data associated with the weather database 120 may be communicated to the notification system 102. In some embodiments, the weather database 120 may be configured to communicate information/data to the notification system 102. In various embodiments, a device coupled to, a system or device monitoring weather data, a device obtaining data from and/or regarding weather data, and/or another suitable system or device associated with a modality may be configured to communicate information/data to the notification system 102. In some implementations, the weather database 120 may include weather conditions, predicted weather events, forecasts, historical weather data, etc. for various locations.

The weather database 120 may include data relating to a plurality of weather conditions for one or more geographic locations. The weather conditions may be or may be related to or indicative of one or more predicted weather events. For example, the weather conditions may be or include temperatures, wind speeds, pressure systems, or other weather-related measurements. Further, the weather conditions may indicate a predicted weather event. For instance, high wind speeds may be weather conditions indicative of a tornado (e.g., a predicted weather event).

In various embodiments, the weather database 120 may include data relating to a plurality of predicted weather events. Predicted weather events may include, but are not limited to, thunderstorms, rain, wildfires, hail, wind, ice, snowstorms, precipitation (e.g., rain, sleet, etc.), tropical weather conditions, low visibility conditions, lightning, air quality indices, pollen indices, tornadoes, flooding, etc.

The weather data of the weather database 120 may also include specific data about weather events. For example, the weather data may include information about a size of hail, a size of waves, locations of lightning strikes, and/or any other granular data that may be specific to weather phenomena occurring during a weather event.

In some embodiments, the notification system 102 may be configured to receive information/data associated with the weather database 120. For example, the notification system 102 may receive geolocation and/or telematics data associated with the weather database 120. In certain implementations, the notification system 102 may be configured to receive location data associated with the weather database 120. For instance, the notification system 102 may receive location data and corresponding weather conditions for each location. In various embodiments, the weather database 120 may be configured to receive location data and weather conditions for predetermined locations.

In various implementations, the notification system 102 may be configured to receive historic weather-related information associated with the weather database 120. For example, the notification system 102 may receive information relating to historic weather conditions and past weather events for a plurality of locations. The notification system 102 may also be configured to receive near-term forecast data and/or long-term climate data. For instance, the near-term forecast data may include forecasted weather conditions and predicted weather events for various locations for two weeks into the future. The long-term climate data may include predicted trends in weather or climate for various locations.

In certain implementations, the weather database 120 may include a plurality of predetermined notifications. The predetermined notifications may be related to predicted weather events and may include an indication or description of the weather event. For example, when the weather information indicates a severe thunderstorm is predicted to occur in a predetermined period of time, the weather database 120 may store an associated, general notification that a severe thunderstorm may occur in a predefined area.

In various embodiments, the notification system 102 may extract data from the weather database 120. For instance, the notification system 102 may extract weather data only for a certain area (e.g., a state, a county, a zip code, etc.). Along with the extracted weather data, the notification system 102 may extract the predetermined notifications associated with the weather data. When generating customized notifications, the notification system 102 may utilize a predetermined notification or generate a new notification.

The weather database 120 may be associated with a third-party provider. For example, the weather database may be associated with a weather service. The weather database 120 may receive weather information from various data sources. For example, the weather database 120 may receive weather information from weather stations, radar, satellite, lightning networks, weather models, weather balloons, computer-generated models, flight data, government data, etc. In various embodiments, the notification system 102 may retrieve the data from the weather database 120 via an API call.

In some embodiments, the notification system 102 may be configured to receive audiovisual information (e.g., images, videos, audio recordings, sensor data, other data, etc.) captured by the weather database 120 and/or a device associated with or monitoring the weather database 120 (e.g., the user device 110), for example to assess and/or verify the various weather conditions described herein.

As shown, the notification system 102 may be configured to receive information/data associated with the third-party system 130. The third-party system 130 may include a third-party application 132. While the weather alert system 100 is shown to include one third-party system 130, it is contemplated herein that the weather alert system 100 may include a plurality of third-party systems 130. In certain embodiments, the notification system 102 may be configured to receive weather data and/or weather-related information/data associated with the third-party system 130. Additionally or alternatively, the notification system 102 may be configured to receive information associated the user via the third-party system 130.

In various embodiments, the third-party system 130 may be associated with a weather entity. For example, the third-party system 130 may be associated with a weather monitoring provider. The notification system 102 may (e.g., automatically, and/or in response to an input from a user or operator) receive weather information from the third-party system 130. For instance, the notification system 102 may receive weather information, including weather conditions (e.g., temperatures, pressure measurements, wind speeds, cloud formations, etc.), predicted weather events (e.g., thunderstorms, hail, snowstorms, wildfires, etc.), and/or other weather information.

In some embodiments, the notification system 102 may be configured to receive historic information associated with the weather information, for example historic weather patterns and/or weather trends for various locations (e.g., counties, zip codes, etc.) and/or other historic weather-related information.

In various implementations, the third-party system 130 may be associated with a provider different than the provider of the provider system 140. The third-party system 130 may be utilized by a user. For example, the third-party system 130 may be a company storing personal data related to the user.

The user may utilize a third-party application 132. For instance, the third-party system 130 may be a mobile phone application. Additionally or alternatively, the user may utilize the mobile phone application. The notification system 102 may be configured to receive user information associated with the third-party system 130. For example, the notification system 102 may receive user information relevant to one or more policies of the user.

As shown, information/data associated with the provider system 140 may be communicated to the notification system 102. In various embodiments, the provider system 140 may be configured to communicate information/data to the notification system 102. In some implementations, a device coupled to, a component implemented with the provider system 140, an application or program housed and/or executed on the provider system 140, and/or another suitable component associated with the provider system 140 may be configured to communicate information/data to the notification system 102.

The provider system 140 may include a provider application 142. In some embodiments, the provider system 140 may be associated with a company or entity that provides protective services (e.g., insurance, etc.) to a user or operator (e.g., a user or operator associated with the user device 110), a company or service provider (e.g., OEM or a provider associated with the third-party system 130), and/or over one or more products or services (e.g., associated with the weather database 120, etc.). In certain embodiments, the provider system 140 may include the notification system 102, as described herein. The provider system 140 may be configured to communicate with the notification system 102 (and/or the user device 110), for example to provide policy information.

In exemplary implementations, the provider associated with the provider system 140 may be an insurance provider. The insurance provider may have a plurality of provider applications 142 associated with various types of insurance policies offered to customers. For example, the provider may offer health insurance policies, homeowner policies, automobile policies, life policies, boat policies, etc. Each provider application 142 may be associated with different types of policies.

As shown, the notification system 102 may be configured to communicate with the computing system 150. In some embodiments, the computing system 150 may be a cloud-based computing system, for example to provide digital connections between different computing devices and/or systems (e.g., as described herein). The computing system 150 may be a virtual reality (VR) system or augmented reality (AR) system, for example to provide digital connections between a plurality of metadata sources, where the metadata sources are integrated within the VR system or AR system.

In various embodiments, the computing system 150 may be implemented using one or more computing devices, for example operating alone and/or in combination. In some implementations, the computing system 150 may be implemented using computing architectures like multiple distributed servers, and/or similar computing devices and/or systems. In exemplary implementations, the computing system 150 may be a server (e.g., including a processor coupled to a memory), for example to store and/or recall data and applications within the memory. In certain embodiments, the computing system 150 may be another suitable computing system, for example distributed across multiple systems or devices (e.g., which may be located within a single building or facility, or distributed across multiple different buildings or facilities), or within a single computer (e.g., one server, housing, etc.). All such implementations are contemplated herein.

As shown, the notification system 102 may be configured to communicate with the storage system 160 (e.g., having the database 162). In some embodiments, the notification system 102 communicates with the storage system 160, either directly (e.g., via the network 170) or indirectly (e.g., via the user device 110, the weather database 120, etc.). The storage system 160 may include one or more devices (e.g., RAM, ROM, Flash memory, hard disk storage, etc.) for storing data and/or computer code for implementing and/or facilitating the various processes, layers, and/or circuits described herein. The storage system 160 may be or include volatile memory or non-volatile memory, and may include database components, object code components, script components, and/or any other type of information structure for supporting the various activities and information structures described herein.

As shown, notification system 102 may be configured to communicate with the user database 180. The user database 180 may include user information 184. In various embodiments, information/data associated with the user database 180 may be communicated to the notification system 102. In various embodiments, a device coupled to, a system or device monitoring weather data, a device obtaining data from and/or regarding weather data, and/or another suitable system or device associated with a modality may be configured to communicate information/data to the notification system 102. In certain implementations, the user database 180 may include information relating to a protection policy of the user (e.g., policy information 182) and/or information relating to the user (e.g., user information 184).

The user database 180 may include data relating to current users. A user may be a user (e.g., of the user device 110) or a customer (e.g., of the provider system 140) that has taken out one or more insurance policies with a specific insurance provider. The user database 180 may store information relating to policies belonging to the user as policy information 182. The user database 180 may store information relating to the user as user information 184.

In various embodiments, the policy information 182 may include data on types of policies. For example, policy information 182 may include, for each user, information on what types of policies the user has and details on the assets covered by the policies (or endorsements). For example, policies may be homeowner's policies, automotive or vehicle policies, health policies, life policies, renters policies, personal articles or personal belongings policies, umbrella policies, parametric policies, various endorsements, etc.

The policy information 182 may include an address or location of one or more assets of the user. Specifically, the policy information may include an address of assets covered by a policy of the user.

The user information 184 may include data on users that have policies associated with the provider. The user information may include information relevant to policies of the user. For example, the user information 184 may include historical location data of the user. The user information 184 may be information obtained by the provider system 140 when a user obtains one or more policies with the provider. In various embodiments, the provider system 140 may obtain user information 184 via a third-party system (e.g., third-party system 130). The user information 184 may include location data of the user.

The user database 180 may also include information relating to an asset relevant to the user and/or a protection policy, but that is not itself covered by a policy. For example, a user may own a home and have a homeowner's policy associated with the home. On the home's lot, the user may have a pool. The pool may not be an asset covered by the policy, but the data compiler 250 may receive information regarding the pool (e.g., that a pool is located in the yard of the home) because the pool is associated with the home covered by the homeowner's policy.

In certain embodiments, the notification system 102 may be configured to receive information/data associated with the user database 180. For example, the notification system 102 may receive geolocation and/or telematics data associated with the user database 180. In various implementations, the notification system 102 may be configured to receive location data associated with the user database 180. For instance, the notification system 102 may receive location data for the user and/or location information for assets covered under policies (e.g., a location of a house, a residential address of the user, etc.).

In certain embodiments, and as will be discussed in greater detail, the notification system 102 may also be configured to generate data. For example, the notification system 102 may include components (e.g., a data compiler, an analyzer, a notification analyzer, and a database) that obtain, analyze, process, generate, store, and/or communicate data.

In various embodiments, the notification system 102 may be configured to generate and/or provide one or more weather notifications to protect an asset of a user from being impacted by a predicted weather event. For example, the notification system 102 may (i) receive weather data from a database; (ii) determine, from the weather data, weather conditions indicative of a predicted weather event beginning within a predefined time period; (iii) receive a location of a user; (iv) receive information relating to one or more policies of the user; (v) determine that the predicted weather event is relevant to the user based upon the location of the user and the information relating to the one or more policies of the user; and/or (vi) automatically initiate an action to mitigate a potential impact of the predicted weather event on the user responsive to the determination that the predicted weather event is relevant to the user.

### Exemplary Notification Generation System

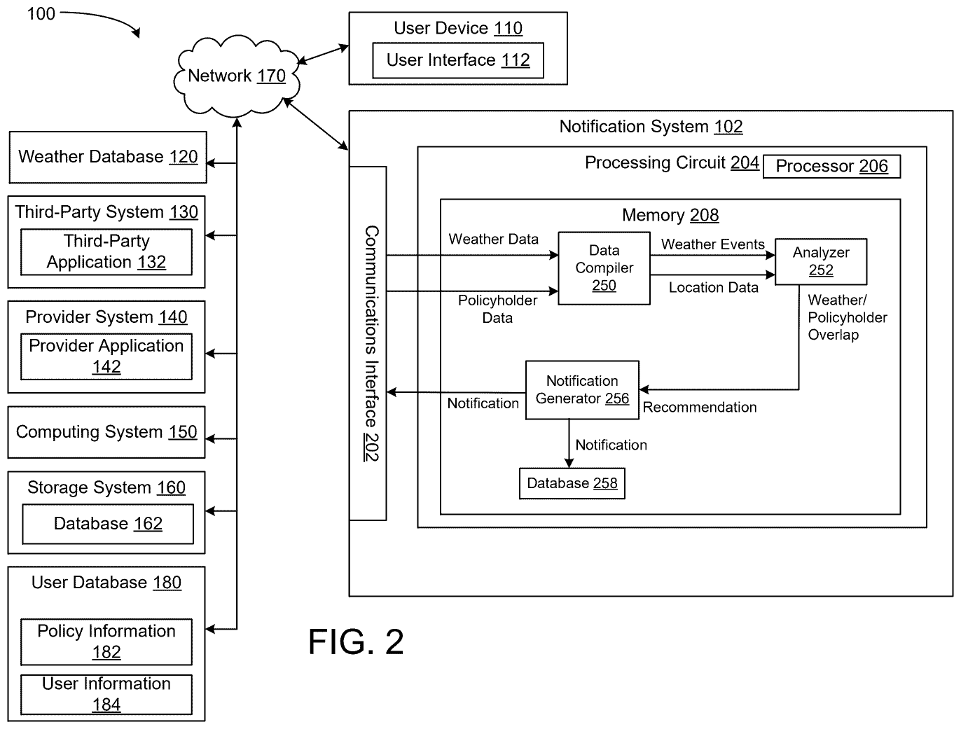

Referring now to FIG. 2, a block diagram of the exemplary notification generation system, e.g., the notification system 102, is shown in greater detail, according to some embodiments. As discussed above, the notification system 102 may be configured to generate and/or provide one or more weather alert notifications. For example, the notification system 102 may be configured to receive weather data and information on a location of a user and generate a notification alerting a user (e.g., a policyholder) of an upcoming weather event.

In exemplary implementations, the notification system 102 may be configured to receive weather data from a database (e.g., the weather database 120). The notification system 102 may determine, from the weather data, weather conditions indicative of a predicted weather event that begins within a predefined time period. The notification system 102 may also receive a location of a user.

In some embodiments, the notification system 102 may also be configured to determine that the predicted weather event is relevant to the user based upon the location of the user. The notification system 102 may automatically initiate an action to mitigate a potential impact of the predicted weather event on the user, responsive to the determination that the predicted weather event is relevant to the user.

As shown in FIG. 2, the notification system 102 may be communicably connected to the user device 110, the weather database 120, the third-party system 130, the provider system 140, the computing system 150, the storage system 160, and the user database 180 (e.g., via the network 170). In some embodiments, the notification system 102 may be communicably connected to other suitable systems and/or devices (e.g., via the network 170), including those devices mentioned elsewhere herein. It should be understood that some or all of the components of the notification system 102, the user device 110, the weather database 120, the third-party system 130, the provider system 140, the computing system 150, the storage system 160, the network 170, and/or the user database 180 may be implemented as art of a cloud-based computing system configured to obtain, process, and/or communicate data from one or more external devices or sources.

Similarly, some, or all, of the components of the notification system 102, the user device 110, the weather database 120, the third-party system 130, the provider system 140, the computing system 150, the storage system 160, the network 170, and/or the user database 180 may be integrated within a single device or be distributed across multiple separate systems or devices. In various embodiments, notification system 102, the user device 110, the weather database 120, the third-party system 130, the provider system 140, the computing system 150, the storage system 160, the network 170, and/or the user database 180 are components of a controller, a device controller, a field controller, a computer work station, a client device, and/or another system or device that receives, processes, and/or communicates data from/to devices or other data sources.

As shown, the notification system 102 may include a communications interface 202 and a processing circuit 204 having a processor 206 and a memory 208. The communications interface 202 may include wired or wireless communications interfaces (e.g., jacks, antennas, transmitters, receivers, transceivers, wire terminals, etc.) for communicating data between the notification system 102 and external systems or devices (e.g., the user device 110, the weather database 120, the third-party system 130, the provider system 140, the computing system 150, the storage system 160, etc.). In various implementations, the communications interface 202 facilitates communications between the notification system 102 and one or more external applications and/or interfaces (e.g., the user interface 112, the third-party application 132, the provider application 142 etc.), for example to allow a remote user or operator to control, monitor, and/or adjust components of the notification system 102.

Further, the communications interface 202 may be configured to communicate with external systems and/or devices using any of a variety of communications protocols (e.g., HTTP(S), WebSocket, CoAP, MQTT, etc.) and/or any of a variety of other protocols. Advantageously, the notification system 102 may obtain, ingest, and process data from any type of system or device, regardless of the communications protocol used by the system or device.

As shown, the notification system 102 may include the processing circuit 204 having the processor 206 and the memory 208. While shown as single components, it should be appreciated that the notification system 102 may include one or more processing circuits, including one or more processors and memory.

In certain embodiments, the notification system 102 may include a plurality of processors, memories, interfaces, and/or other components distributed across multiple devices or systems, which are communicably coupled via a network (e.g., the network 170). For example, in a cloud-based or distributed implementation, the notification system 102 may include multiple discrete computing devices, each of which include a processor 206, memory 208, communications interface 202, and/or other components of the notification system 102. Tasks performed by the notification system 102 may be distributed across multiple systems or devices, which may be located within a single building or facility or distributed across multiple buildings or facilities. In other embodiments, the notification system 102 itself may be implemented within a single computer (e.g., one server, one housing, etc.). All such implementations are contemplated herein.

The processor 206 may be a general purpose or specific purpose processor, an application specific integrated circuit (ASIC), one or more field programmable gate arrays (FPGAs), a group of processing components, or other suitable processing components. The processor 206 may further be configured to execute computer code or instructions stored in the memory 208 or received from other computer readable media (e.g., USB or other local storage, network storage, a remote server, etc.).

The memory 208 may include one or more devices (e.g., memory units, memory devices, storage devices, etc.) for storing data and/or computer code for completing and/or facilitating the various processes described in the present disclosure. The memory 208 may include random access memory (RAM), read-only memory (ROM), hard drive storage, temporary storage, non-volatile memory, flash memory, optical memory, or any other suitable memory for storing software objects and/or computer instructions. In some embodiments, the memory 208 may include database components, object code components, script components, and/or any other type of information structure for supporting the various activities and information structures described in the present disclosure. The memory 208 may be communicably connected to the processor 206 via the processing circuit 204, and may include computer code for executing (e.g., by the processor 206) one or more processes described herein. When the processor 206 executes instructions stored in the memory 208, the processor 206 may configure the processing circuit 204 to complete such activities.

As shown, the notification system 102 (e.g., the memory 208) may include a data compiler 250, a weather and user information analyzer, shown as an analyzer 252, a notification generator 256, and a database 258. The following paragraphs describe some of the general functions performed by each of the components 250-258 of the notification system 102. It should be noted that the number and type of components shown is merely illustrative and, in various implementations, implementations of the notification system 102 may have additional, fewer, and/or different components than those illustrated in FIG. 2.

In certain embodiments, the data compiler 250 may be configured to obtain input data, analyze the input data, and/or generate output data to be communicated to other components of the notification system 102. For example, the data compiler 250 may obtain (e.g., receive, request, pull, etc.) weather data. The weather data may be received from an external system or device (e.g., the weather database 120, an edge device, the user device 110, etc.), for example via the communications interface 202.

The weather data may include weather conditions for various locations. Weather conditions may be various readings, measurements, etc. of weather phenomena. For example, weather conditions may include temperatures, fronts, pressure systems, amounts of precipitation, wind speeds, etc. The weather data may also include predicted weather events. The predicted weather events may be based upon the weather conditions. Weather events may be predicted based upon the weather conditions. For example, weather conditions may be below freezing temperatures and snowfall above a certain threshold value, which may cause a predicted weather event to be a snowstorm. In various embodiments, weather conditions may be the same as predicted weather events.

The weather data may include a geographic location. For example, the weather data may include weather conditions and predicted weather events for various locations (e.g., within a state, within a region, within a city, etc.). The data compiler 250 may obtain weather data (e.g., weather conditions and predicted weather events) for specific locations only. For instance, the data compiler 250 may obtain weather data for specific counties in a specific state rather than obtaining weather data for an entire region. For example, the weather database may contain information indicating that a thunderstorm is affecting several counties in a state. The data compiler 250 may obtain weather data for the affected counties.

The weather data may include an indication that a predicted weather event will begin within a predetermined time period. For example, the weather data may indicate that a hurricane is predicted to occur in three days in a certain area. The data compiler 250 may receive this information with the weather data.

In various embodiments, the data compiler 250 may receive weather data, weather conditions, and/or predicted weather events and associated time periods of the weather events. In various other embodiments, the data compiler 250 may receive weather data (e.g., from the weather database 120) and may determine weather conditions and/or predicted weather events. That is, the data compiler may analyze the weather data to determine weather conditions in various locations and generate predicted weather events resulting from the weather conditions. The data compiler 250 may also, for each predicted weather event, determine a first predefined time period during which the predicted weather event may begin.

The data compiler 250 may also determine a second predefined time period indicating a duration of the predicted weather event. For instance, the data compiler 250 may determine that a snowstorm will occur within the next three days. The data compiler 250 may also determine that the snowstorm will last for four days.

The data compiler 250 may receive granular data regarding one or more weather conditions or weather events. For example, for a particular weather event, the data compiler 250 may receive information such as an air pressure, a size of precipitation, an amount of precipitation, etc.

The weather data may also include a plurality of predetermined weather alerts associated with the weather conditions and/or predicted weather events. For example, whenever and wherever a certain weather event is identified in the weather data, an associated, predetermined or pre-generated notification may be associated with the weather event.

The predetermined notification may include generic information about the weather event. For instance, if the weather event is a thunderstorm, the notification may include information about where the thunderstorm is occurring and an estimated duration of the thunderstorm.

In some embodiments, weather data may include information associated with a computing system (e.g., the computing system 150) and/or a storage system (e.g., the storage system 160). The weather data may include historic and/or real-time travel or navigation related information, for example from (e.g., directly, or indirectly) the computing system 150 and/or the storage system 160, as described herein. In various embodiments, weather data may be received by the notification system 102 in real-time and/or at one or more series or intervals (e.g., hourly, daily, etc., automatically in response to a detected weather event, the weather database 120, the third-party system 130, the provider system 140, etc.).

In certain implementations, the data compiler 250 may be configured to obtain (e.g., receive, request, pull, etc.) user data. The user information may be received from an external system or device (e.g., an edge device, the user device 110, the third-party system 130, the provider system 140, the computing system 150, the storage system 160, the user database 180, etc.), for example via the communications interface 202. In various embodiments, the user data may be obtained from the user database 180. For example, the data compiler 250 may obtain policy information 182 (e.g., information relating to policies held by the user) and/or user information 184 (e.g., personal information relating to the user).

In various implementations, the user data may include information associated with a protection policy associated with the user. The protection policy may be utilized by the user to protect at least one of the user and/or property of the user. For example, the user data may include information relating to policies taken out by the user. This information may include a type of policy or policies.

The policy information may also include specifics about the policy or policies. For example, the policy may be an automotive policy and specifics about the policy include a make and model of the covered vehicle. In certain embodiments, the policy data may include information about lapsed policies (e.g., previous policies no longer active). The policy data may also include previously-filed claims relating to one or more policies.

The policy data may also include information about the user or assets related to, but not covered by, a policy. For example, a user may own a home and have a homeowner's policy associated with the home. On the home's lot, the user may have a trampoline or other personal articles. The trampoline may not be an asset covered by the policy, but the data compiler 250 may receive information regarding the trampoline (e.g., that a trampoline is located in the yard of the home) because the trampoline is associated with the home covered by the homeowner's policy.

In exemplary implementations, the policy data may include information about assets covered by one or more policies, such as itemized assets and information about the itemized assets. For example, the policy data may include that a user has an ATV, a small craft, jewelry, parcels of land, household goods, etc. covered by a policy. The data may also indicate information about the items, such as a location of the item, an estimated value of the item, etc.

In various embodiments, the user data may include information associated with the user. The user information may be information associated with a user device (e.g., the user device 110) of the user. For example, the user data may include geolocation and/or telematics data associated with the user device 110 that may be used to determine a location of the user (e.g., a location, a speed or direction of movement, historic geolocation and/or telematics data, geolocation and/or telematics data provided in real-time, etc.).

Additionally or alternatively, the user data may include information associated with a user or operator of a user device (e.g., the user device 110 or other computing device(s), including those mentioned herein). For example, the user data may include information associated with an application on the user device 110 (e.g., a health or fitness application, etc.).

The user information may be collected and/or gathered via a user device (e.g., the user device 110). For instance, the user data may include audiovisual information (e.g., captured via a microphone or camera of the user device 110, and/or captured via a mobile device, AR glasses, VR headset, voice bot, chatbot, wearable, or other computing devices, including those mentioned herein), for example audiovisual (including audio, visual, video, image, and/or graphical information, data, and sensor data) information and related data captured in real-time and/or historical audiovisual information and related data.

In some embodiments, the user data may include information associated with personal information of the user. For example, the user data may include life events, such as birthdate or marriage status. The user data may also include an age of the user, information relating to a spouse (e.g., age), a number of dependents and associated information (e.g., age, driving status, etc.). The user information may also include habits of the user and/or dependents, such as driving habits, lifestyle habits, health information, etc. The user data may also include historic information, for example historical information associated with locations of the user, previous addresses, and/or other similar user related information.

Additionally or alternatively, the user data may include information associated with a third-party system (e.g., the third-party system 130). In certain embodiments, the third-party system 130 is one of a plurality of third-party systems 130, such that the user data may include information associated with a plurality of third-party systems 130.

For example, the third-party system 130 may be associated with an entity related to a protection policy of the user. For example, the third-party system 130 may be associated with the user's medical provider, and the user data may include previous health visits, copays, procedures covered by a policy, etc. In various embodiments, the third-party system 130 may be associated with an entity such as an autobody shop, and the user data may include repairs made to the vehicle, damage related to an accident covered by an automobile policy, etc.

The notification system 102 may generate custom weather alerts and/or notifications based upon the user data. For example, the notification system 102 may receive information from the user data that may be unavailable to, for example, a generic weather alert database (e.g., a weather application built into a user's mobile device, etc.). Based upon the user data, the notification system 102 may generate a notification that may be unable to be provided by other systems (e.g., generic weather systems). For example, the notification system 102 may generate, using, at least in part, the user data to provide an alert or notification relating to assets belonging to the user, etc.

For instance, the notification system 102 may generate a notification including an indication that flash floods are occurring at a location of the user, based upon receiving user information indicating that the user or dependent is currently driving in a vehicle during a weather event (e.g., the flash flooding).

The notification system 102 may also utilize the user data to generate more specific notifications than, for example, a generic weather application may provide. For example, a generic weather application may provide a notification to a user indicating that flooding is possible based upon a current location of the user. The notification system 102 may utilize the user data to generate notifications including information about weather events occurring at a location of one or more assets of the user.

In certain implementations, the weather data and/or user data may include information associated with a provider system 140. The provider system 140 may be associated with a company that provides protective services (e.g., insurance, etc.) to a user or operator, a company, service provider, and/or one or more products or services. The user data may include one or more protection policy parameters associated with one or more users, operators, companies, service providers, products, and/or services. Further, the user data (e.g., one or more policy parameters) may be provided using historical policy parameter information (e.g., historic policy characteristics, etc.), and/or one or more additional policy parameters (e.g., cost, discounts, availability and/or policy source, a policy availability location, a time over which the policy is available, a product or service over which the policy is available, a destination range or location over which the policy is available, eligibility requirements, ability to group or bundle different policies or parameters, available discounts or rewards associated with a policy or parameter, etc.), as described herein.

As shown, the data compiler 250 may be configured to obtain input data (e.g., weather data, user data, etc.), analyze the input data, and/or generate output data. For example, the data compiler 250 may be configured to obtain (e.g., receive, request, pull, etc.) a weather data and/or user data, analyze (e.g., compile, process, etc.) the data, and predicted weather events and location data of the user and assets associated with one or more policies. The predicted weather events and location data may be communicated to another component of the notification system 102 (e.g., the analyzer 252). In certain embodiments, the weather data and/or user data may include data associated with weather events and the user, and/or one or more instructions to identify (e.g., generate, determine, etc.) a plurality of customized notifications associated with the weather data and user data, as will be discussed below.

In various embodiments, the analyzer 252 may be configured to obtain input data, analyze the input data, and/or generate output data to be communicated to other components of the notification system 102. For example, the analyzer 252 may obtain (e.g., receive, request, pull, etc.) predicted weather events and location data, analyze the predicted weather events and location data, and/or generate an overlap between predicted weather events and locations of a user and/or assets covered by policies of the user, for example including a plurality of weather events and corresponding affected users and/or assets. The analyzer 252 may be configured to determine that the predicted weather event received from the data compiler 250 is relevant to the user. The analyzer 252 may determine the relevancy of the predicted weather event based upon the location of the user and information relating to the one or more policies of the user received from the data compiler 250.

As shown, the analyzer 252 may be configured to analyze the predicted weather events and location data and generate an overlap between the predicted weather events and user location data. In some embodiments, the overlap between the predicted weather events and user location data identifies that a predicted weather event for a certain geographic location is relevant to the user. The predicted weather event may impact the user, one or more policies, and/or one or more assets. For example, the predicted weather event may cause damage to an asset, put a user in danger, cause a claim to be filed, etc. By determining an overlap between the predicted weather event and locations of the user and/or assets relating to policies of the user, the analyzer 252 may determine that the predicted weather event is relevant to the user.

The analyzer 252 may be configured to determine the weather conditions at a current location of the user by extracting weather data from the database for a geographical area within a predefined distance from the current location of the user. For example, in various embodiments, the analyzer 252 may receive weather locations for various locations from the data compiler 250. The analyzer 252 may receive a current location of a user from the data compiler 250.

The analyzer 252 may define a predetermined distance or radius from the location of the user. The predetermined distance may be, for example, 1 mile, 5 miles, 10 miles, 5 kilometers, 10 kilometers, etc. The geographical area may be, for example, a circular region around the current location of the user. The analyzer 252 may determine that a predicted weather event is expected to occur in the geographical area. Responsive to a determination that the predicted weather event is expected to occur in the geographical area, the analyzer 252 may determine an overlap between the user and the predicted weather event and may determine that the predicted weather event is relevant to the user. In various embodiments, the overlap may be shown on a map (e.g., as an overlap between an indication of a weather event and a geographical area within a predefined radius of a location of the user). The predicted weather event may be relevant to the user when the predicted weather event may impact the user, a protection policy, and/or an asset.

In certain implementations, the analyzer 252 may be configured to determine the weather conditions at a location of at least one asset covered by the one or more policies of the user by extracting weather data from the database for a geographical area within a predefined distance from a location of the at least one asset. For example, in various embodiments, the analyzer 252 may receive weather locations for various locations from the data compiler 250. The analyzer 252 may receive a location of an asset covered by a policy of the user from the data compiler 250. For example, the analyzer 252 may receive a location of a vehicle covered by an auto policy, a location of a house covered by a homeowner's policy, etc.

The analyzer 252 may define a distance or radius from the location of the asset. The distance may be, for example, 1 mile, 5 miles, 10 miles, 5 kilometers, 10 kilometers, etc. In example embodiments, the distance may be a geographic area around or surrounding the location of the asset and/or the location of the user or user. For example, the geographic area may be a city, a county, a portion of a state, etc. As such, the notification system 102 may generate a notification for weather alerts associated with a particular city, a county, a portion of a state, etc. The distance may be, in some implementations, a predefined distance. The geographical area may be, for example, a circular region around the location of the asset.

In various embodiments, the analyzer 252 may determine a plurality of locations and geographical areas corresponding to a plurality of assets covered by policies. The analyzer 252 may determine that a predicted weather event is expected to occur in the geographical area. Responsive to a determination that the predicted weather event is expected to occur in the geographical area, the analyzer 252 may determine an overlap between the asset and the predicted weather event and may determine that the predicted weather event is relevant to the user. In various embodiments, the overlap may be shown on a map (e.g., as an overlap between an indication of a weather event and a geographical area within a predefined radius of a location of the asset). The predicted weather event may be relevant to the user when the predicted weather event may impact the user, a policy, and/or an asset.

In certain embodiments, the analyzer 252 may be configured to determine the overlap between the weather data and a user and/or asset using information associated with a user device (e.g., the user device 110). The analyzer 252 may also be configured to determine that the predicted weather evet is relevant to the user using information associated with a user device. For example, the analyzer 252 may determine one or more overlaps between weather events and user/asset locations using geolocation and/or telematics data associated with the user device 110 (e.g., a current location of the user device 110).

Additionally or alternatively, the analyzer 252 may be configured to determine the overlap between the weather data and a user and/or asset using information associated with the weather data (e.g., the weather database 120). The analyzer 252 may also be configured to determine that the predicted weather evet is relevant to the user using information associated with the weather data (e.g., the weather database 120). For example, the analyzer 252 may determine one or more overlaps between weather events and user/asset locations using geolocation and/or telematics data associated with at least one of the weather database 120 (e.g., a current location, etc.). The analyzer 252 may determine one or more of the overlaps and/or relevancy of the weather event to the user as described herein.

In exemplary implementations, the analyzer 252 may be configured to determine the overlap between the weather data and a user and/or asset using information associated with a third-party system (e.g., the third-party system 130). The analyzer 252 may also be configured to determine that the predicted weather event is relevant to the user using information associated with a third-party system (e.g., the third-party system 130). For example, the analyzer 252 may determine one or more of the overlaps using user information, policy information, weather data, etc. as described herein.

In some embodiments, the analyzer 252 may be configured to determine overlap between the weather data and a user and/or asset using information associated with a provider system (e.g., the provider system 140). The analyzer 252 may also be configured to determine that the predicted weather evet is relevant to the user using information associated with a provider system (e.g., the provider system 140). For example, the analyzer 252 may be configured to determine one or more of the overlaps using a user information, policy information, and/or weather data from the provider system 140.

Additionally or alternatively, the analyzer 252 may be configured to determine one or more of the overlaps and/or determinations that the weather event is relevant to the user using information associated with a computing system (e.g., the computing system 150) and/or a storage system (e.g., the storage system 160). For instance, the analyzer 252 may determine one or more of the overlaps using historic and/or real-time weather data and/or user data associated with the storage system 160 and/or the computing system 150.

In some embodiments, the analyzer 252 may be configured to determine overlap between the weather data and a user and/or asset using information associated with a user database (e.g., the user database 180). The analyzer 252 may also be configured to determine that the predicted weather evet is relevant to the user using information associated with a user database (e.g., the user database 180). For example, the analyzer 252 may be configured to determine one or more of the overlaps using policy information 182 and/or user information 184 from the user database 180.

In certain embodiments, the analyzer 252 may be configured to determine that the predicted weather event is relevant to the user using information associated with a user device (e.g., the user device 110), a weather database (e.g., the weather database 120), a third-party system (e.g., the third-party system 130), a provider system (e.g., the provider system 140), and/or a user database (e.g., the user database 180) as described herein. In certain implementations, the analyzer 252 may be configured to determine that the predicted weather event is relevant to the user using information associated with a computing system (e.g., the computing system 150) and/or a storage system (e.g., the storage system 160), as described herein.

As shown, the analyzer 252 may be configured to obtain input data (e.g., the weather events, location data, etc.), analyze the input data, and/or generate output data. For example, the analyzer 252 may be configured to obtain (e.g., receive, request, pull, etc.) weather data and location data of a user and/or assets (e.g., via the data compiler 250), analyze the weather data and the location data, and generate an overlap between a location of the predicted weather event and a user/asset. The analyzer 252 may also determine that the predicted weather event is relevant to the user.

In some embodiments, the notification generator 256 may be configured to obtain input data, analyze the input data, and/or generate output data to be communicated to other components of the notification system 102. For example, the notification generator 256 may obtain (e.g., receive, request, pull, etc.), from the analyzer 252, information regarding an overlap between a location of the predicted weather event and a user/asset. The analyzer 252 may also determine that the predicted weather event is relevant to the user, analyze the information, and/or generate a notification, for example displaying a weather alert in the notification.

The notification generator 256 may generate the notification for the user based upon the determination that the predicted weather event is relevant to the user based upon the weather conditions, the location of the user, and/or information relating to one or more policies of the user. The notification may include information relevant to the user and/or at least one policy of the one or more policies. For example, the notification generator 256 may generate the notification responsive to determining that the predicted weather event is relevant to the user (e.g., based upon data from the analyzer 252).

In various embodiments, the notification generator 256 may additionally display the notification to the user. For example, the notification generator 256 may transmit the notification to the user device 110 via the communications interface 202.

The notification generator 256 may be displayed to the user a predetermined length of time before the beginning of the predicted weather event. For example, the notification may be displayed 30 minutes, two hours, one day, etc. before the beginning of the predicted weather event. The predetermined length of time may be based upon, for example, a type of predicted weather event, the information relevant to the user, etc. For instance, notifications relating to predicted weather events that are predicted a greater period of time before the beginning of the event may be displayed a longer predetermined length of time before the beginning of the event compared to a weather event predicted less time before the beginning of the event.

In various embodiments, the predetermined period of time before the beginning of the predicted weather event may be determined based upon a type or severity of the weather event. For example, a snowstorm predicted to last one week may be displayed further in advance of the event than a high pollen index lasting one day. In various embodiments, the weather data received from the weather database 120 may include information relating to the length of time prior to the beginning of the weather event that the notification is displayed. In other embodiments, one or more components of the notification system 102 may determine the predetermined length of time.

The notification generator 256 may generate a plurality of notifications. For example, the notification generator 256 may generate multiple notifications relating to a single weather event. For instance, the weather event may be a lightning storm. The notification generator 256 may generate a first notification responsive to weather data indicating a first instance of lightning. Lightning may not occur for thirty minutes and may then return. The notification generator 256 may generate a second notification responsive to the weather data indicating a second instance of lightning.

The notification generator 256 may generate a plurality of notifications within one time period for multiple weather events. For example, a hailstorm may occur simultaneously with a thunderstorm. The notification generator 256 may generate one or more notifications relating to the hailstorm and one or more notifications relating to the thunderstorm.

Additionally or alternatively, the notification generator 256 may generate the notification based upon information relating to the user (e.g., an age of the user, a number of dependents, driving habits, etc.). For example, the notification may be based upon the determination that the predicted weather event is relevant to the user based upon the weather conditions, the location of the user, information relating to one or more policies of the user, and/or information relating to the user. In various implementations, the notification generator 256 may generate a notification based upon an itemized asset included in the policy data. For example, the notification generator 256 may generate a notification directed to a specific make and model of a vehicle covered by a policy. As a further example, the notification generator 256 may generate a notification directed to an ATV owned by the user that appears in the policy data as an itemized asset.

Alternatively or additionally, the notification generator 256 may be configured to receive a plurality of predetermined notifications relating to the weather data. For example, the weather database 120 may contain weather data and predetermined notifications relating to or associated with each type of predicted weather event. The predetermined notifications may be transmitted to the data compiler 250 along with or alternative to the weather conditions, predicted weather events, and/or other weather data. The predetermined notifications may be transmitted to the analyzer 252 and/or the notification generator 256.

The notification generator 256 may determine whether to generate a custom notification or use a predetermined notification. For example, the notification generator 256 may generate a notification using information from within the notification system 102. The notification may include custom information generated by the notification generator (e.g., information relating to an asset of the user).

Responsive to a determination by the notification generator 256 to utilize a predetermined notification, the notification may be customized but may include information generated by, for example, the weather database 120. For example, the predetermined notification may include general information relating to a predicted weather event.

The notification generator 256 may utilize the information relating to the predicted weather event and may additionally or alternatively customize the notification based upon the location of the user, weather data at the location of the user (e.g., the predicted weather event or a determination that the predicted weather event is relevant to the user), and the information relating to the one or more policies of the user. For example, the notification system 102 may generate a notification indicating an upcoming weather event at a location of an asset of the user.

In certain embodiments, the notification generator 256 may be further configured to communicate the customized notification to one or more devices, systems, and/or environments. For example, the notification generator 256 may be configured to communicate the notification to the user device 110 (e.g., via the communications interface 202), for example for display (e.g., via the user interface 112) or voice reproduction, such as in the case of a voice bot, ChatGPT bot, etc.

Additionally or alternatively, the notification generator 256 may be configured to communicate the notification to the database 258 and/or the storage system 160 (e.g., via the communications interface 202 via the network 170), for example for storage and/or subsequent notification generation. In certain embodiments, the notification generator 256 may be configured to communicate the notification to the third-party system 130, the provider system 140, the computing system 150, and/or the user database 180 (e.g., via the communications interface 202 via the network 170), for example for storage and/or subsequent analysis (e.g., authorization, verification, etc.).

### Exemplary Weather Alert System & Functionality

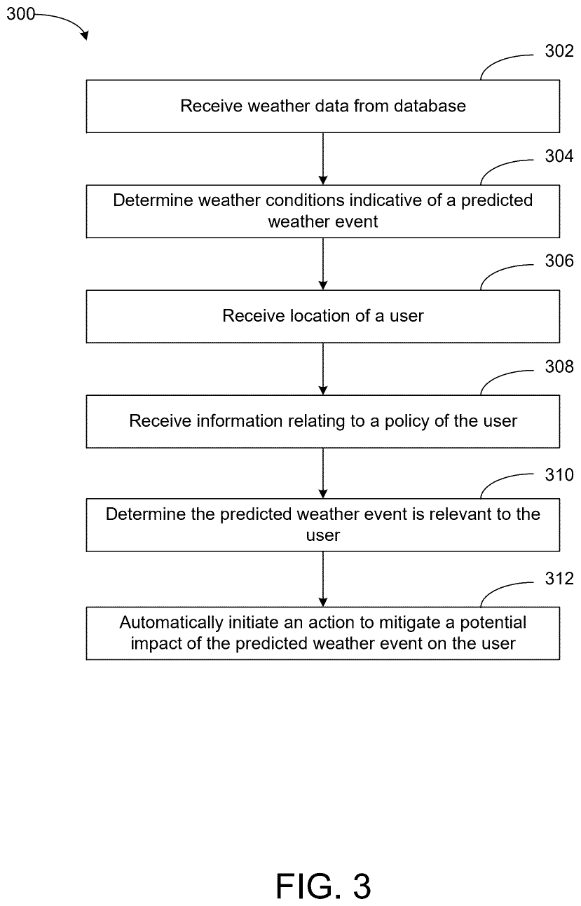

Referring now to FIG. 3, a computer-implemented or computer-based process, shown as process 300, for providing and/or generating a notification relating to a predicted weather event, is shown, according to some embodiments. The notification may be associated with a weather event predicted to potentially impact a user (e.g., a policyholder) or protection policy associated with a provider (e.g., an insurance provider). Computer-implemented process 300 may be implemented by any and/or all the components of the weather alert system 100 of FIGS. 1-2 (e.g., the notification system 102, etc.). It should be appreciated that any and/or all the process 300 may be implemented by other systems, devices, and/or components (e.g., components of the weather alert system 100, the notification system 102, etc.). Further, it should be appreciated that in various embodiments, process 300 may implemented using additional, different, and/or fewer operations, actions, and/or functionality.

Computer-implemented process 300 may include receiving weather data from a database (block 302), according to some embodiments. The notification system 102 may receive the weather data. The weather data may include geographic location information. For example, the weather data may identify a plurality of weather conditions and/or weather events at a plurality of geographic locations. The weather data may be received from an external or remote device (e.g., an edge device, the user device 110, the weather database 120, the provider system 140, etc.).

In certain implementations, computer-implemented process 300 may include receiving, from the database, a plurality of predetermined notifications relating to the weather data. For example, the weather data may include a plurality of types of weather conditions and/or weather events. For each weather condition and/or event, the weather database may have an associated predetermined or pre-generated notification. The predetermined notification may include information about the weather condition/weather event, such as a description of the event or metrics related to the event (e.g., temperature, precipitation level, etc.).

Computer-implemented process 300 may include determining, from the weather data received at block 302, weather conditions indicative of a predicted weather event beginning within a predefined time period (block 304), according to some embodiments. The notification system 102 may determine the weather conditions and/or the predicted weather event. For example, a component of the notification system 102 (e.g., the data compiler 250) may receive weather data and may subsequently determine weather conditions.

The weather conditions may be indicative of a weather event predicted to occur within a predefined time period. For example, the weather conditions may be metrics such as temperature, wind speed, etc. that are indicative of a weather event or phenomenon (e.g., a storm, tornado, wildfire, etc.). The weather data may include a forecast or prediction of a time period within which the weather event is predicted to occur.

Computer-implemented process 300 may include receiving a location of the user (block 306), according to some embodiments. The notification system 102 may receive the location of the user. The location of the user may be a current location. For example, the notification system 102 may receive a location of the user via geolocation or telematics data from a user device associated with the user.

Computer-implemented process 300 may include receiving information relating to one or more policies of the user (block 308), according to some embodiments. The notification system 102 may receive information relating to one or more policies of the user. The notification system 102 may receive the protection policy information from, for example, the user database 180. The one or more policies (and/or endorsements) may include at least one of a homeowner policy, a life policy, an automotive policy, renters policy, a personal articles policy, a parametric policy, various or related endorsements, or a health policy. In various embodiments, the information relating to the one or more policies may an address of a building.

In certain implementations, computer-implemented process 300 may include determining the weather conditions at a current location of the user. The weather conditions may be determined by extracting weather data from the database (e.g., the weather database 120) for a geographical area within a predefined distance from the current location of the user. The notification system 102 may determine the weather conditions. For example, the notification system 102 may determine a location of a user traveling on a highway. The notification system 102 may define a geographical area as encompassing a twenty mile radius from the location of the vehicle. The notification system 102 may extract weather data for the geographical area and determine weather conditions and/or predicted weather events within the geographical area.

In some embodiments, computer-implemented process 300 may include determining the weather conditions at a location of at least one asset covered by the one or more policies of the user. The weather conditions may be determined by extracting weather data from the database (e.g., the weather database 120) for a geographical area within a predefined distance from a location of the at least one asset. For example, the notification system 102 may determine a location of a vehicle covered by an auto policy. The notification system 102 may define a geographical area as encompassing a twenty mile radius from the location of the vehicle. The notification system 102 may extract weather data for the geographical area and determine weather conditions and/or predicted weather events within the geographical area.

Computer-implemented process 300 may include determining that the predicted weather event is relevant to the user based upon the location of the user and the information relating to the one or more policies of the user for protecting at least one of the user or property of the user (block 310), according to some embodiments. The notification system 102 may determine that the predicted weather event is relevant to the user. For example, the notification system 102 may determine that a predicted weather event is near (e.g., within a predefined radius of) the location of the user.

The notification system 102 may determine that a protection policy of the user may be impacted by the predetermined weather event. For instance, the notification system 102 may determine that a house may be impacted by (e.g., is in a location of) a hailstorm.

Computer-implemented process 300 may include automatically initiating an action to mitigate a potential impact of the predicted weather event on the user responsive to the determination that the predicted weather event is relevant to the user (block 312), according to some embodiments. The notification system 102 may automatically initiate the action. For example, the action may include generating a notification.

Additionally or alternatively, computer-implemented process 300 may include generating a notification for the user based upon the determination that the predicted weather event is relevant to the user based upon at least one of: the weather conditions, the location of the user, and the information relating to the one or more policies of the user. The notification may include information related to the predicted weather event. For example, the notification system 102 may generate a notification to display to the user, for example, via a user device (e.g., user device 110). In various embodiments, the computer-implemented process 300 may include displaying the notification to the user a predetermined length of time before the beginning of the predicted weather event. For example, the notification may be displayed one day before the weather event is predicted to occur.

In some examples, the computer-implemented process 300 may include receiving, from the database (e.g., the weather database 120), a plurality of predetermined notifications relating to the weather data. The computer-implemented process 300 may further include selecting at least one of the plurality of predetermined notifications for presentation to the user. The computer-implemented process 300 may further include displaying at least one of the plurality of predetermined notifications to the user. The computer-implemented process 300 may further include determining that the predicted weather event is occurring or predicted to occur at or near a location of an asset of the user, and displaying at least one of the plurality of predetermined notifications to the user based on the determination that the predicted weather event is occurring or predicted to occur at or near the location of the asset of the user.

As an illustrative example, a user may have one or more insurance policies with an insurance provider. A notification system for the provider may receive weather data from a database. The notification system may determine, from the received weather data, weather conditions indicative of a flash flood. The notification system may determine that the flood is predicted to begin in fifteen minutes. The notification system may also receive a location of the user indicating that the user is currently driving on the road. The notification system may also receive information that the user has homeowner's insurance and automobile insurance through the provider. The notification system may determine that the flash flood is relevant to the user by determining that the flash flood is predicted to occur in a location near the current location of the user and near a location of the home of the user.

### Exemplary User Interface

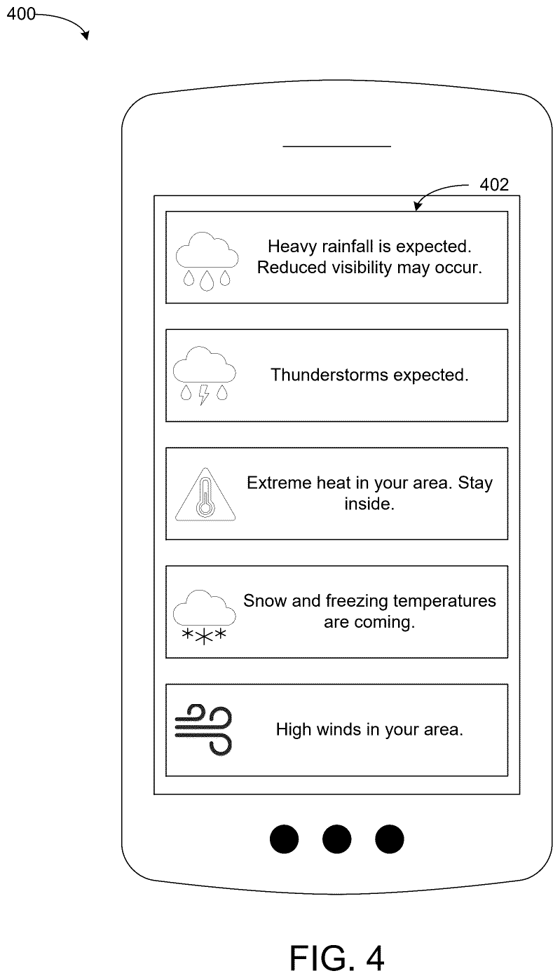

Referring now to FIG. 4, is a diagram of an exemplary user interface displaying customized notifications to a user (e.g., a policyholder), according to some embodiments. A user device 400 is shown having a user interface. In various embodiments, the user device 400 may be the same as or similar to the user device 110, and the user interface may be the same as or similar to the user interface 112. The user interface may include a plurality of generated notifications 402.

In various embodiments, the user device may be implemented by any and/or all the components of the weather alert system 100 of FIGS. 1-2 (e.g., the notification system 102, etc.). It should be appreciated that any and/or all the generated notifications may be implemented by other systems, devices, and/or components (e.g., components of the weather alert system 100, the notification system 102, etc.). It should be appreciated that in some implementations, the user interface and/or generated notifications may be implemented using additional, different, and/or fewer operations, actions, and/or functionality.

As shown in FIG. 4, the user device 110 may include a plurality of notifications 402. Each notification 402 may include an icon indicating the weather conditions and/or predicted weather event that the notification is associated with. Each notification 402 may also include text indicating information about the weather event. For example, a notification may indicate that heavy rainfall is expected (e.g., an indication of the predicted weather event). The notification may further include an implication or potential impact of the weather event (e.g., that reduced visibility may occur).

In various embodiments, the user may receive a plurality of notifications. The plurality of notifications may be related to different weather events occurring simultaneously and/or successively (e.g., overlapping, occurring concurrently, etc.). For example, the user may receive a first notification related to a thunderstorm and may receive a second notification related to an extreme heat warning within the same time period.

### Exemplary Weather Alerts

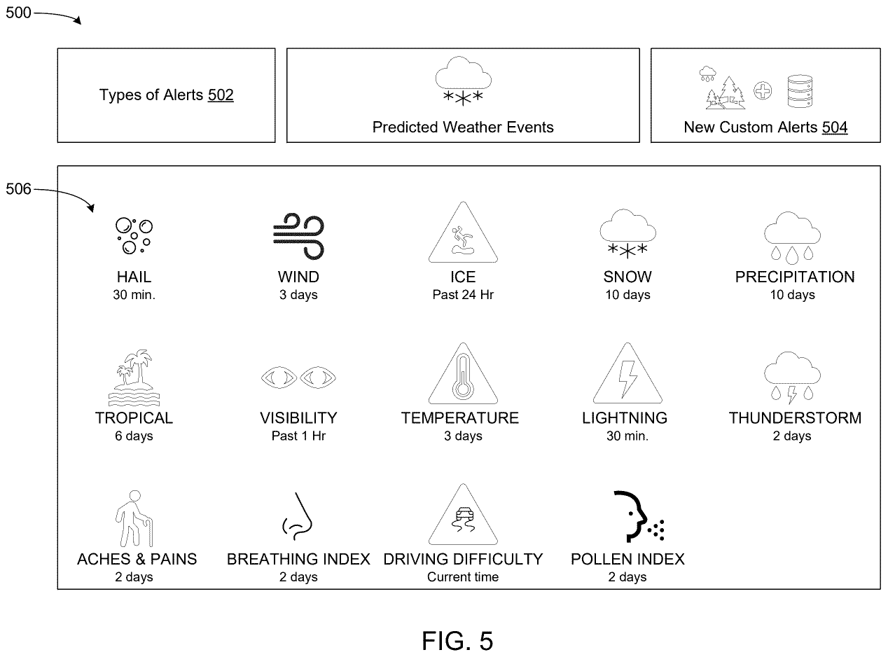

Referring now to FIG. 5, a diagram 500 of exemplary weather alerts to be customized based upon a protection policy of a user (e.g., a policyholder) is shown, according to some embodiments. In various embodiments, the diagram 500 may be an interface associated with the notification system 102, the weather database 120, or any other component of the weather alert system 100.

The diagram 500 may include types of alerts 502. The types of alerts may include, for example, a listing of various weather alerts, watches, warnings, etc. for a plurality of weather conditions and/or weather events. Types of alerts may include, for example, watches, warning, advisories, etc. for various conditions (e.g., precipitation, flooding, winter weather, extreme temperatures, tornadoes, etc.). In various embodiments, the types of alerts 502 may be or include predetermined notifications generated by, for example, the weather database 120.

The diagram may also include a new custom alerts option 504. For example, the notification system 102 may create a custom alert instead of utilizing a predetermined notification. Creating a custom alert may allow the notification system 102 to generate more specific weather alerts and notifications than may be permitted by a predetermined notification.

The diagram 500 may also include a plurality of weather alert icons 506. The weather alert icons may include a graphic, icon, or image associated with a plurality of weather events. The icons 506 may be displayed on the user device 110 as part of a customized notification. Each icon 506 may include a name of the weather alert and a duration of time. The duration of time may indicate a period of time in which the alert has been issued. For example, the ice alert may indicate that ice has been present for the past 24 hours. In various embodiments, the duration of time may be a length of time until a predicted weather event associated with the weather alert is expected to occur. For example, the duration of time associated with the hail icon 506 may indicate that hail is expected to arrive in 30 minutes. The icons 506 may not be limited to the icons displayed in FIG. 5.

### Exemplary Machine Learning and Generative AI

As discussed elsewhere, some embodiments may utilize machine learning, generative artificial intelligence, or other advanced computing techniques. As such, in some embodiments, generative artificial intelligence (AI) models (also referred to as generative machine learning (ML) models) and/or other AI/ML models discussed herein may be implemented via and/or coupled to one or more voice bots and/or chatbots that may be configured to utilize artificial intelligence and/or machine learning techniques. For instance, the voice and/or chatbot may be a ChatGPT chatbot and/or a ChatGPT-based bot. The voice and/or chatbot may employ supervised, unsupervised, and/or semi-supervised machine learning techniques, which may be followed by, and/or used in conjunction with, reinforced and/or reinforcement learning techniques. The voice bot, chatbot, ChatGPT bot, ChatGPT-based bot, and/or other such generative model may generate audible or verbal output, text or textual output, visual or graphical output, output for use with speakers and/or display screens of a mobile computing device, and/or other types of output for user and/or other computer or bot consumption.

Noted above, in various embodiments, a chatbot or other computing device may be configured to implement machine learning, such that the computing device “learns” to analyze, organize, and/or process data without being explicitly programmed. Machine learning and/or artificial intelligence may be implemented through machine learning methods and algorithms. In one exemplary embodiment, a machine learning module may be configured to implement the ML methods and algorithms.

As used herein, a voice bot, chatbot, ChatGPT bot, ChatGPT-based bot, and/or other such generative model (referred to broadly as “chatbot” herein) may refer to a specialized system for implementing, training, utilizing, and/or otherwise providing an AI or ML model to a user for dialogue interaction (e.g., “chatting”). Depending on the embodiment, the chatbot may utilize and/or be trained according to language models, such as natural language processing (NLP) models and/or large language models (LLMs). Similarly, the chatbot may utilize and/or be trained according to generative adversarial network (GAN) techniques, such as the machine learning techniques, algorithms, and systems described in more detail below.

The chatbot may receive inputs from a user via text input, spoken input, gesture input, etc. The chatbot may then use AI and/or ML techniques as described herein to process and analyze the input before determining an output and displaying the output to the user. Depending on the embodiment, the output may be in a same or different form than the input (e.g., spoken, text, gestures, etc.), may include images, and/or may otherwise communicate the output to the user in an overarching dialogue format.

In various embodiments, at least one of a plurality of ML methods and algorithms may be applied to implement and/or train the chatbot, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, a chatbot ML module employs supervised learning, which involves identifying patterns in existing data to make predictions about subsequently received data. Specifically, the chatbot ML module may be “trained” using training data, which includes example inputs and associated example outputs. Based upon the training data, the chatbot ML module may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiment, a processing element may be trained by providing it with a large sample of data with known characteristics or features.

In another embodiment, the chatbot ML module may employ unsupervised learning, which involves finding meaningful relationships in unorganized data. Unlike supervised learning, unsupervised learning does not involve user-initiated training based upon example inputs with associated outputs. Rather, in unsupervised learning, the chatbot ML module may organize unlabeled data according to a relationship determined by at least one ML method/algorithm employed by the chatbot ML module. Unorganized data may include any combination of data inputs and/or ML outputs as described above.

In yet another embodiment, the chatbot ML module may employ semi-supervised learning, which involves using thousands of individual supervised machine learning iterations to generate a structure across the multiple inputs and outputs. In this way, the chatbot ML module may be able to find meaningful relationships in the data, similar to unsupervised learning, while leveraging known characteristics or features in the data to make predictions via a ML output.

In yet another embodiment, the chatbot ML module may employ reinforcement learning, which involves optimizing outputs based upon feedback from a reward signal. Specifically, the chatbot ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In certain embodiments, the chatbot ML module may be used in conjunction with the machine vision, image recognition, object identification, AR glasses, VR headsets, other input/output devices, and/or other image processing techniques discussed below. Additionally or alternatively, in certain implementations, the chatbot ML module may be configured and/or trained to implement one or more aspects of the machine vision, image recognition, objection identification, and/or other image processing techniques discussed below.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In various embodiments, a computer program is provided, and the program is embodied on a computer readable medium. In some implementations, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In certain embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes.

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method operations, actions, or functionality may be varied or re-sequenced according to alternative embodiments. Other substitutions, modifications, changes, and omissions may be made in the design, operating conditions, and arrangement of the example embodiments without departing from the scope of the present disclosure.

As used herein, an element or operation recited in the singular and proceeded with the word “a” or “an” should be understood as not excluding plural elements or operations, unless such exclusion is explicitly recited. Furthermore, references to “exemplary embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed under 35 U.S.C. § 112(f) unless traditional means-plus-function language is expressly recited, such as “means for” or “step for” language being expressly recited in the claim(s).

Although the Figures show a specific order of method operations, actions, or functionality, the order of such may differ from what is depicted. Also, two or more operations, actions, or functionalities may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection operations or actions, processing operations or actions, comparison operations or actions, and decision operations or actions.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the functionality and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. Additionally or alternatively, the operations may be performed by a combination of one or more central or offsite computing devices/servers and one or more local controllers/computing devices. All such implementations are contemplated within the scope of the present disclosure.

Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A computer system for generating customized alerts for a user and mitigating impact of weather events, the system comprising:
one or more memory devices having instructions stored thereon that, when executed by one or more processors, cause the one or more processors to perform operations comprising:
receiving weather data from a database;
determining, from the weather data, weather conditions indicative of a predicted weather event beginning within a predefined time period;
receiving a location of the user;
receiving information relating to one or more protection policies of the user;
determining that the predicted weather event is relevant to the user based upon the location of the user and the information relating to the one or more protection policies of the user for protecting at least one of the user or property of the user; and
automatically initiating an action to mitigate a potential impact of the predicted weather event on the user responsive to the determination that the predicted weather event is relevant to the user.

2. The system of claim 1, wherein automatically initiating the action comprises:
generating a notification for the user based upon the determination that the predicted weather event is relevant to the user based upon, at least one of the weather conditions, the location of the user, and the information relating to the one or more protection policies of the user, the notification comprising information related to the predicted weather event.

3. The system of claim 2, wherein the instructions further cause the one or more processors to perform operations comprising:
displaying the notification to the user a length of time before the beginning of the predicted weather event.

4. The system of claim 1, wherein the instructions further cause the one or more processors to perform operations comprising determining the weather conditions at a current location of the user by extracting weather data from the database for a geographical area within a predefined distance from the current location of the user.

5. The system of claim 1, wherein the information relating to the one or more protection policies is an address of a building.

6. The system of claim 1, wherein the instructions further cause the one or more processors to perform operations comprising:
receiving, from the database, a plurality of predetermined notifications relating to the weather data;
selecting at least one of the plurality of predetermined notifications for presentation to the user; and
displaying the at least one of the plurality of predetermined notifications to the user.

7. The system of claim 6, wherein the instructions further cause the one or more processors to perform operations comprising:
determining that the predicted weather event is occurring or predicted to occur at or near a location of an asset of the user; and
displaying at least one of the plurality of predetermined notifications to the user based on the determination that the predicted weather event is occurring or predicted to occur at or near the location of the asset of the user.

8. A computer-implemented method for generating customized alerts for a user and mitigating impact of weather events, the method comprising:
receiving, by one or more processors, weather data from a database;
determining, by the one or more processors, from the weather data, weather conditions indicative of a predicted weather event beginning within a predefined time period;
receiving, by the one or more processors, a location of a user;
receiving, by the one or more processors, information relating to one or more protection policies of the user;
determining, by the one or more processors, that the predicted weather event is relevant to the user based upon the location of the user and the information relating to the one or more protection policies of the user for protecting at least one of the user or property of the user; and
automatically initiating an action, by the one or more processors, to mitigate a potential impact of the predicted weather event on the user responsive to the determination that the predicted weather event is relevant to the user.

9. The computer-implemented method of claim 8, wherein automatically initiating the action comprises:
generating a notification for the user based upon the determination that the predicted weather event is relevant to the user based upon at least one of the weather conditions, the location of the user, and the information relating to the one or more protection policies of the user, the notification comprising information related to the predicted weather event.

10. The computer-implemented method of claim 9, wherein the computer-implemented method further comprises:
displaying, by the one or more processors, the notification to the user a predetermined length of time before the beginning of the predicted weather event.

11. The computer-implemented method of claim 9, wherein the computer-implemented method further comprises determining the weather conditions at a current location of the user by extracting weather data from the database for a geographical area within a predefined distance from the current location of the user.

12. The computer-implemented method of claim 8, wherein the information relating to the one or more protection policies is an address of a building.

13. The computer-implemented method of claim 8, wherein the computer-implemented method further comprises:
receiving, from the database, a plurality of predetermined notifications relating to the weather data;
selecting at least one of the plurality of predetermined notifications for presentation to the user; and
displaying the at least one of the plurality of predetermined notifications to the user.

14. The computer-implemented method of claim 13, wherein the computer-implemented method further comprises:
determining that the predicted weather event is occurring or predicted to occur at or near a location of an asset of the user; and
displaying at least one of the plurality of predetermined notifications to the user based on the determination that the predicted weather event is occurring or predicted to occur at or near the location of the asset of the user.

15. A non-transitory computer-readable medium storing instructions thereon for generating customized alerts for a user and mitigating impact of weather events, the instructions, when executed by one or more processors, cause the one or more processors to:
receive, by the one or more processors, weather data from a database;
determine, by the one or more processors, from the weather data, weather conditions indicative of a predicted weather event beginning within a predefined time period;
receive, by the one or more processors, a location of a user;
receive, by the one or more processors, information relating to one or more protection policies of the user;
determine, by the one or more processors, that the predicted weather event is relevant to the user based upon the location of the user and the information relating to the one or more protection policies of the user; and
automatically initiate, by the one or more processors, an action to mitigate a potential impact of the predicted weather event on the user responsive to the determination that the predicted weather event is relevant to the user.

16. The non-transitory computer-readable medium of claim 15, wherein automatically initiating the action comprises:
generating a notification for the user based upon the determination that the predicted weather event is relevant to the user based upon at least one of: the weather conditions, the location of the user, and the information relating to the one or more protection policies of the user, the notification comprising information related to the predicted weather event.

17. The non-transitory computer-readable medium of claim 15, wherein the instructions further cause the one or more processors to: determine the weather conditions at a current location of the user by extracting weather data from the database for a geographical area within a predefined distance from the current location of the user.

18. The non-transitory computer-readable medium of claim 15, wherein the information relating to the one or more protection policies is an address of a building.

19. The non-transitory computer-readable medium of claim 15, wherein the instructions further cause the one or more processors to:
receive, from the database, a plurality of predetermined notifications relating to the weather data;
select at least one of the plurality of predetermined notifications for presentation to the user; and
display the at least one of the plurality of predetermined notifications to the user.

20. The non-transitory computer-readable medium of claim 19, wherein the instructions further cause the one or more processors to:
determine that the predicted weather event is occurring or predicted to occur at or near a location of an asset of the user; and
display at least one of the plurality of predetermined notifications to the user based on the determination that the predicted weather event is occurring or predicted to occur at or near the location of the asset of the user.
